(19) United States
(12) Patent Application Publication
(10) Pub. No.: US 2007/0176000 A1
(43) Pub. Date: Aug. 2, 2007

(54) Selective image encoding and replacement

(75) Inventors: Paul Cattrone, Pleasant Hill, CA (US); Hiroshi Tomite, Palo Alto, CA (US); Vlvek Pathak, Mountain View, CA (US)

Correspondence Address: YING CHEN, 255 S. GRAND AVE., # 215, LOS ANGELES, CA, 90012, US

(73) Assignee: Konica Minolta Systems Laboratory, Inc.

(21) Appl. No.: 11/343,326

(22) Filed: Jan. 31, 2006

(51) Int. Cl. G06K 7/10

(52) U.S. Cl. 235/462.01

(57) ABSTRACT

A method of processing a document is described in which selected area(s) of the document, such as areas containing sensitive information, with a barcode(s) that represents the information in the selected area(s). Selection of the area(s) may be done by a user or automatically. When the processed document is printed or electronically displayed, the selected area(s) is replaced with barcode(s) so the information in the area(s) cannot be visually discerned by a human observer. The intended recipient or reader of the document can decode it using a decoder to display the document, including the selected area(s), in the original form. The method may be implemented in a computer, a scanner/copier, a printer or the like.

### BACKGROUND OF THE INVENTION

1. Field of the Invention

This invention relates to image encoding, and in particular, it relates to the application of barcode in image encoding.

2. Description of the Related Art

Barcode is a form of machine-readable symbology for encoding data, and has been widely employed in a variety of application fields. Two-dimensional barcode (2d barcode), which is one mode of such symbology, can be used to encode text, numbers, images, and binary data streams in general, and has been used in identification cards, shipping labels, etc. One widely used 2d barcode standard is the PDF417 standard, and software and hardware products have been available to print and read such 2d barcode. Color barcode has also been proposed.

### SUMMARY OF THE INVENTION

The present invention is directed to a method and apparatus using 2d barcode or other forms of machine-readable symbology to encode image data. An object of the present invention is to provide a method to use barcode locally to encode and overwrite sensitive or important areas of a document.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other objects, as embodied and broadly described, the present invention provides a method for processing a document, which includes: (a) selecting at least one area of a source document; (b) processing data representing the at least one area in the source document to generate at least one set of barcode data; and (c) replacing data representing the at least one area in the source document with the at least one set of barcode data to generate a processed document.

In another aspect, the present invention provides a method of restoring a processed document that contains at least one set of barcode data in at least one area, the at least one set of barcode data representing original document data in the at least one area, the method includes: (d) detecting and extracting the at least one set of barcode data in the processed document; (e) processing the extracted data to generate original document data in the at least one area; and (f) replacing the at least one set of barcode data with the original document data in the at least one area to generate a restored document.

The present invention is also directed to computer program product that causes a data processing apparatus to perform the above methods.

In yet another aspect, the present invention provides a data processing apparatus which includes: a scanning section for scanning a hard copy document to generate a source document; a user interface section including a display device for displaying a source document and an input device for selecting at least one area of the displayed document; and a control section for controlling the data processing apparatus, the control section including a data processing section for processing data in the at least one area of a source document to generate at least one set of barcode data, and replacing data in the at least one area of the source document with the at least one set of barcode data to generate a processed document. The data processing apparatus may also include a printing section for printing the processed document on a recording medium, and a communication interface section for connecting to an external device, wherein the control section transmits the processed document to the external device via the communication interface section.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates an original document and a document processed using a method according to an embodiment of the present invention.

FIG. 2 is a flow chart showing a selective image encoding and replacement method according to an embodiment of the present invention.

FIG. 3 is a flow chart showing a decoding method to restore the original document according to an embodiment of the present invention.

FIG. 4 schematically illustrates a scanner/copier device according to an embodiment of the present invention.

### DETAILED DESCRIPTION OF THE PREFERRED EMBODIMENTS

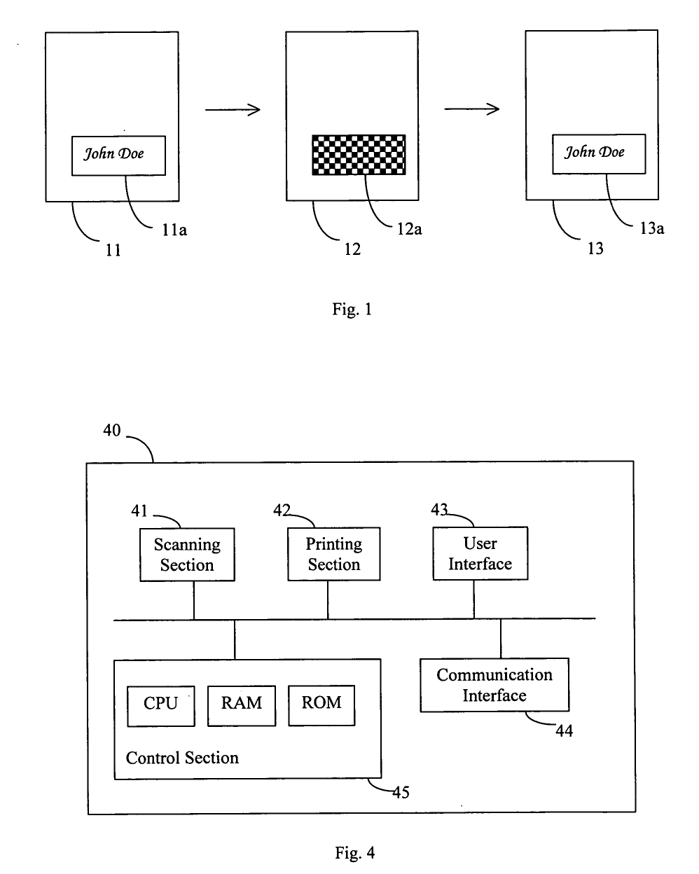

An embodiment of the present invention processes a document by replacing one or more selected areas of the document, such as area(s) containing sensitive information like signature, fingerprint, picture, identification number, social security number or account number, etc., with at least one barcode that represents the information in the selected area(s) in an encoded form. When the processed document is printed or electronically displayed, the selective area(s) is replaced with the at least one barcode so the information in the area(s) cannot be visually discerned by a human observer. The intended recipient or reader of the document can decode it using a decoder to display the document, including the selected area(s), in the original form. As an example, FIG. 1 illustrates an original document 11 containing a signature area 11a, a processed document 12 in which the signature area is replaced with a 2d barcode 12a, and a restored document 13 in which the signature area 13a is restored to the original image.

Such a selective image encoding and replacement method allows for more efficient storage of data in barcode by not encoding the less important or sensitive areas of the document. In many practical applications, a document is often based on a known template having certain content, size and shape, where only a fixed number of areas contain document-specific information (i.e. information unique to that document). Examples include forms, form documents, checks, etc. For such a document, it is often not necessary to encode an obscure the entire document in order to provide security and privacy protection.

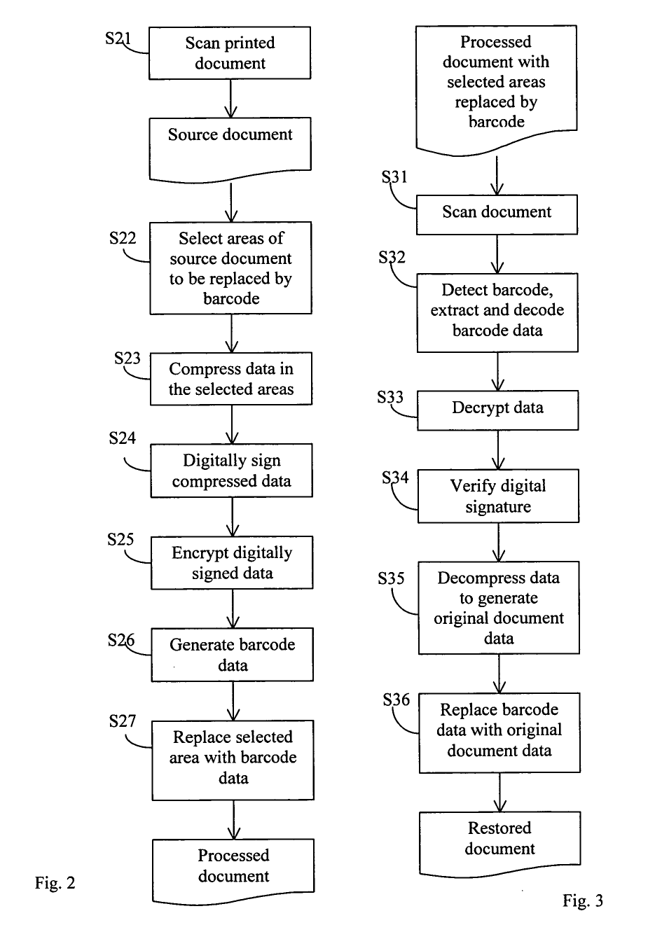

A method of selective image encoding and replacement according to embodiments of the present invention is now described with reference to FIG. 2. The method may be implemented, preferably by software or firmware, in a data processing apparatus such as a computer, scanner, copier, printer, etc. First, if the document to be processed is a printed document (a hard copy), it is scanned and converted into an electronic form (step S21). This step is omitted if the document to be processed is already in an electronic form. Hereinafter, the electronic form of the document to be processed is referred to as a source document. The source document may be in a variety of digital forms, including text, graphics, image, etc. and combinations of the above. One or more areas of the source document are then selected as area(s) to be replaced by at least one barcode (step S22). The area selection may be done manually, in which case the document is displayed on a display device (e.g. a computer monitor, a screen of a scanner device, etc.), and the user uses an input device (e.g. a mouse, touch screen, etc.) to select one or more areas to be replaced. The area selection may also be done automatically by the data processing apparatus, especially in the case where the source document is of a known format (e.g. a form) with pre-determined areas to be replaced. The source document may include at the header area another barcode or symbology that represents a form type of the source document so that the data processing apparatus can know where the area(s) to be selected is located. A selected area may be defined by its coordinates on the printed or displayed document, such as in the case where the document is an image, or defined (e.g. by using metadata) as being associated with certain contents of the document even though its actual location on the printed or displayed page may vary, such as in the case of an image, field of data, etc. that are embedded in a text document. Thus, an “area” of a document broadly refers to either a physical area of the document, or a portion of the content of the document regardless of its physical location on the printed document. The data representing the selected area of the document may be an image, a text string, graphics, or other form of data depending on the nature of the document and the selected area.

The data processing apparatus then compresses the data in the selected area(s) of the source document (step S23), digitally signs the data (step S24, optional), encrypts the data (step S25, optional), and generates at least one set of barcode data from the data (step S26). The barcode data therefore represents the data in the selected area(s) of the source document. Optionally, desired metadata may be added to the barcode data for document control or other purposes. Note that the digital signature (S24) and encryption (S25) steps are optional, depending on the level of security desired. The compression step (S23) is also optional, but in the case where the selected area contains image data (such as in a scanned document), compression is preferably performed to reduce the amount of data to be encoded into barcode. If, on the other hand, the data in the selected area is pure text (such as in the case of a Word document containing an identification number to be obscured), then compression may not be necessary. In step S26, the barcode data is generated using any suitable method and pursuant to any suitable standard, either currently existing or may be developed in the future.

As used in this disclosure, the term “barcode” refers to 1d or 2d barcode, color barcode—or more generally, any machine-readable symbology that contains information—in the printed or displayed form. The term “barcode data” refers to data in electronic form that, when printed or displayed, depicts a barcode.

The barcode data generated in step S26 is then used to replace the data in the selected areas of the source document (step S27) to generate a processed document. Here, the term “processed document” refers to an electronic form of the document having been processed as described above. The processed document can then be printed, displayed, stored, and/or transmitted to another device.

In Step 27, replacing the data in the selected area(s) with barcode data may be accomplished in a variety of ways. The barcode data may be inserted in the document in place of the original data representing the selected area (which is deleted). Alternatively, the barcode data may be stored elsewhere in the processed document (with or without deleting the original data representing the selected area), with appropriate metadata that associates the barcode data with the selected area(s) so that when the processed data is printed or displayed, the barcode(s) is printed or displayed in the selected area(s) and the data in the source document is not printed or displayed in the area(s). Other methods of replacing the original data with barcode data may be used, so long as the barcode data is treated in such a way that when the processed document is printed or displayed, the barcode(s) is printed or displayed in the selected area(s).

Before the compressing step (S23), the data processing apparatus checks the data in the selected area(s) to ensure that the data is encodable in barcode. Before the replacing step (S27), the data processing apparatus checks the barcode data to determine whether the selected area(s) have sufficient sizes to print the barcode. These two steps (not shown in FIG. 2) are preferred but not required.

A printed document containing replacement barcode(s) (barcode(s) that replaced area(s) of the original document) in selected area(s) may be restored to the original document by a decoding process illustrated in FIG. 3. First, the document is scanned (step S3 1), and replacement barcode(s) contained therein is detected and the barcode data is extracted (step S32). The scanning step (S31) may be omitted if the document is already in a scanned form. Because the printed document may contain other barcode that did not replace an area of the original image or is not intended to be restored, the replacement barcode may contain information to indicate to the decoder that the barcode is a replacement barcode and the original data is to be restored. The extracted data is then decrypted (if the data has been encrypted) (step S33), and the digital signature (if present) is verified (step S34). The data is then decompressed (if it has been compressed) to generate the original document data (step S35). The barcode data is replaced with the original document data (step S36) to generate the restored document. Again, replacement may be done in any suitable way. The restored document can be displayed, printed, stored or transmitted electronically.

One practical application of the selective image encoding and replacement method is a scanner/copier device that can produce a hard copy or an electronic copy of an original hard copy document with selected area(s) replaced by barcode(s). As shown in FIG. 4, such a scanner/copier device 40 includes a scanning section 41 for scanning a hard copy document to obtain digital data representing the document, a printing section 42 for printing a document, a user interface section 43 for interacting with the user, a communication interface section 44 for communicating with an external device, and a control section 45 for controlling the functions of the scanner/copier device. Such a scanner/copier are sometimes referred to as multifunction machines. The control section 45 contains a processor with associated memory and control software, and is connected with the sections 41 through 44 via an appropriate bus. The user interface section 43 includes at least a control panel for inputting user commands. It may also include a display panel for displaying an image of the scanned document, and an input device such as a mouse or touch screen to allow the user to make a selection of the area(s) to be coded. Such a display panel and input device are required if the scanner/copier is to function in a standalone configuration. If the scanner/copier 40 is connected to an external computer, then the display and input device of the computer can be used to display the scanned image and allow the user to select the area(s) to be replaced by barcode(s). The data processing program for processing the data in the selected area(s) (compression, digital signature, encryption, barcode generation, etc.) may reside in the copier/printer, or in the external computer connected thereto. In operation, the scanning section 41 scans the original hard copy, and an image of the document is displayed on a display, which is either a part of the scanner/copier or a part of the connected computer. The user selects one or more areas to be barcoded using an input device, which is either a part of the scanner/copier or a part of the connected computer. Alternatively, the program may automatically select the area(s) to be barcoded, as described earlier. As another alternative, the program may allow the user to make a selection using a displayed document, and store the selection to be used for scanning subsequent documents that have the same layout. The data processing program processes the data in the selected area(s) to generate barcode data that represents the original data in the selected area(s). Depending on whether the user selected a copy or scan function, the scanner/copier either prints a hard copy of the original document where the selected area(s) is replaced by barcode(s), or stores an electronic version of the original document where the data in the selected area(s) is replaced by barcode data.

Thus, the selective image encoding and replacement method can be embodied in a scanner/copier equipped with a display, an input device and control software that can produce a copy of an original document with selected area(s) replaced by barcode(s) in a stand-alone configuration. The selective image encoding and replacement method can also be embodied in a control program that causes a scanner/copier to produce a copy of an original document with selected area(s) replaced by barcode(s).

Another practical application of the selective image encoding and replacement method is a software program that allows a user to print a document with selected area(s) replaced by barcode(s). The document to be printed (the source document) may originate from any suitable source, include word processing applications, spreadsheet applications, graphics applications, email applications, web browser applications, scanners, digital cameras, etc. When the user prints an electronic document from a computer using such a program, the program displays an image of the document on the computer screen, and allows the user to select the area(s) to be barcoded. Alternatively, the program may automatically select the area(s) to be barcoded, as described earlier. As another alternative, the program may allow the user to make a selection using a displayed document, and store the selection to be used for printing subsequent documents that have the same layout. The program processes the data in the selected area(s) to generate barcode(s) that represents the data in the selected area(s), and causes the document to be printed in which the selected area(s) is replaced by barcode(s). Alternatively, in lieu of printing the document on a medium, the software program may store a processed document in electronic form which, when printed later, will have the selected area(s) replaced by barcode(s).

From the above descriptions, it can be seen that a feature of embodiments of the present invention is to only encode selected area(s) of a document as barcode(s), and to print the barcode(s) in the selected area(s) to replace the original image in the area(s). An advantage of replacing selected sensitive area(s) with barcode(s) is to protect the sensitive area(s) against casual tampering. While a plain copy of a document is easy to alter and re-copy, it is difficult to alter a sensitive area that has been barcoded unless the forger also uses a barcoding technique. If the data in the sensitive area was digitally signed and/or encrypted, a forger will not be able to alter it or not be able to alter it without being detected. Another advantage of encoding sensitive areas of a document is to prevent the sensitive information (identification number, signature, etc.) from being stolen by persons who have opportunities to see a hard copy of a document. For example, if the signature on the back of a credit card is encoded and printed as bar code, an unauthorized user will likely not be able to see the actual image of the signature and therefore not be able to forge the signature. A merchant will be able to see the signature image using a device equipped with an appropriate decoder. (Of course, the signature may also be embedded in the magnetic data on the credit card.)

Compared to encoding the entire document, the selective image encoding and replacement method is more efficient. Often a document contains mostly non-sensitive information, and encoding the entire document would be a waste of effort. Further to this, encoding the entire document would be useless or hard to use in a variety of application fields because the processed document loses human recognizable information at all.

Preferred embodiments of the present invention use 2d barcode to replace the images in the selected area. Other machine-readable symbologies may also be used. For example, one-dimensional barcode may be used, although such barcodes likely would not have sufficient data capacity to store the image data in the original document. For instance, in a case where an image of a social security number (SSN) is included in a source document in a form of image data, the SSN can be converted into character codes by subjecting the area of the SSN to character recognition. Because character coded SSN is usually smaller in capacity than the image of the SSN, one-dimensional barcode might be sufficient to represent such character coded SSN.

In the above descriptions, the term “source document” and “processed document” are used to refer to electronic forms of a document, i.e., electronic signals representing a document. It should be understood that the electronic form of a document may only exist transiently, and electronic signals representing different parts of the document may not exist simultaneously. For example, in a copier embodiment of the present invention, an implementation is possible where a portion (a physical page or part of a page) of the hard copy original image is scanned, one or more areas contained in that portion are selected (automatically or manually) and converted to barcode data, the portion of the image is printed with the selected areas replaced by barcode, and the data is discarded or partially discarded before the next portion of the original image is scanned and similarly processed. Such an implementation is encompassed within the scope of the present invention even though different portions of the source document or processed document exist only transiently at different times.

It will be apparent to those skilled in the art that various modification and variations can be made in the selective image encoding and replacement method and apparatus of the present invention without departing from the spirit or scope of the invention. Thus, it is intended that the present invention cover modifications and variations that come within the scope of the appended claims and their equivalents.

What is claimed is:

1. A method for processing a document comprising:
(a) selecting at least one area of a source document;
(b) processing data representing the at least one area in the source document to generate at least one set of barcode data; and
(c) replacing data representing the at least one area in the source document with the at least one set of barcode data to generate a processed document.

2. The method of claim 1, further comprising scanning a hard copy of an original document to generate the source document.

3. The method of claim 1, further comprising printing the processed document on a medium or displaying the processed document on a display device, wherein the printed or displayed document includes at least one barcode in the at least one area.

4. The method of claim 1, further comprising storing or electronically transmitting the processed document.

5. The method of claim 1, wherein step (a) comprises:
displaying the source document on a display device; and
selecting the at least one area of the displayed source document by a user.

6. The method of claim 1, wherein step (a) comprises automatically selecting the at least one area of the source document.

7. The method of claim 1, wherein the at least one area is defined by its location on the source document when printed or displayed, or defined by a data content of the source document.

8. The method of claim 1, wherein the data representing the at least one area in the source document is text data, graphics data, or image data.

9. The method of claim 1, wherein step (b) comprises compressing data representing the at least one area of the source document.

10. The method of claim 9, wherein step (b) further comprises:
digitally signing the compressed data; and
encrypting the digitally signed data.

11. The method of claim 1, wherein step (b) comprises adding metadata to the barcode data.

12. The method of claim 1, wherein step (b) comprises determining whether the at least one area has a sufficient size to print the barcode data.

13. The method of claim 1, wherein the at least one set of barcode data represents at least one two-dimensional barcode.

14. The method of claim 1, wherein the at least one set of barcode data represent at least one color barcode.

15. A method of restoring a processed document that contains at least one set of barcode data in at least one area, the at least one barcode data representing original document data in the at least one area, the method comprising:
(d) detecting and extracting the at least one set of barcode data in the processed document;
(e) processing the extracted data to generate original document data in the at least one area; and
(f) replacing the at least one set of barcode data with the original document data in the at least one area to generate a restored document.

16. The method of claim 15, further comprising scanning a hard copy document to generate the processed document.

17. The method of claim 15, further comprising printing the restored document on a medium or displaying the restored document on a display device.

18. The method of claim 15, further comprising storing or electronically transmitting the restored document.

19. A computer program product comprising a computer usable medium having a computer readable code embodied therein for controlling a data processing apparatus, the computer readable program code configured to cause the data processing apparatus to execute a process for processing a source document comprising the steps of:
(a) selecting at least one area of a source document;
(b) processing data representing the at least one area in the source document to generate at least one set of barcode data; and
(c) replacing data representing the at least one area in the source document with the at least one set of barcode data to generate a processed document.

20. A computer program product comprising a computer usable medium having a computer readable code embodied therein for controlling a data processing apparatus, the computer readable program code configured to cause the data processing apparatus to execute a process for restoring a processed document that contains barcode data in at least one area which represents original document data in the selected areas, the process comprising the steps of:
(d) detecting and extracting at least one set of barcode data in the processed document;
(e) processing the extracted data to generate original document data in the at least one area; and
(f) replacing the at least one set of barcode data with the original document data in the at least one area to generate a restored document.

21. A data processing apparatus comprising:
a scanning section for scanning a hard copy document to generate a source document;
a user interface section including a display device for displaying a source document and an input device for selecting at least one area of the displayed document; and
a control section for controlling the data processing apparatus, the control section including a data processing section for processing data in the at least one area of the source document to generate at least one set of barcode data, and replacing data in the at least one area of the source document with the at least one set of barcode data to generate a processed document.

22. The apparatus of claim 21, further comprising a printing section for printing the processed document on a recording medium.

23. The apparatus of claim 21, further comprising a communication interface section for connecting to an external device, wherein the control section transmits the processed document to the external device via the communication interface section.
